(19) United States
(12) Patent Application Publication
(10) Pub. No.: US 2014/0072702 A1
(43) Pub. Date: Mar. 13, 2014

(54) INKJET PRINTING OF DENSE AND POROUS CERAMIC LAYERS ONTO POROUS SUBSTRATES FOR MANUFACTURE OF CERAMIC ELECTROCHEMICAL DEVICES

(71) Applicant: Colorado School of Mines, Golden, CO (US)

(72) Inventor: Neal P. Sullivan, Louisville, CO (US)

(73) Assignee: Colorado School of Mines, Golden, CO (US)

(21) Appl. No.: 14/020,436

(22) Filed: Sep. 6, 2013

Related U.S. Application Data
(60) Provisional application No. 61/698,361, filed on Sep. 7, 2012.

(51) Int. Cl. H01M 8/10; H01M 8/12; C09D 11/00

(52) U.S. Cl. CPC H01M 8/1097; C09D 11/30; H01M 8/1253
USPC 427/115; 252/519.33; 429/408; 429/496

(57) ABSTRACT

The present invention relates to a segmented-in-series fuel cell and a method for making the same. The present invention uses an inkjet printer to apply layers of the fuel cell to a substrate, which allows for a controlled application of the fuel cell layers to the substrate. The present invention also discloses an ink material for use in the segmented-in-series fuel cells and a method for making the same.

### CROSS REFERENCE TO RELATED APPLICATIONS

This non-provisional patent application claims the benefit of priority from U.S. Provisional Patent Application No. 61/698,361 filed Sep. 7, 2012, the entire disclosure of which is hereby incorporated by reference in its entirety.

### FIELD OF THE INVENTION

The present invention relates to a segmented-in-series fuel cell and a method for making the same.

### BACKGROUND

The “segmented-in-series” (SIS) solid-oxide fuel cell (SOFC) architecture enables high-voltage, low-current electric-power generation on a single support. Low-cost, readily accessible screen-printing technology is commonly utilized for SIS-device fabrication. However, a limiting feature for screen-printed technology is that the SOFC has a maximum size of about 100 microns. Thus, there is a need for a SOFC which may be on a scale of tens of microns while still maintaining a low cost for manufacturing the SOFC.

### SUMMARY

The present invention relates to inkjet-printing technology which enables SIS-SOFC fabrication on the scale of tens of microns under ambient environmental conditions. These small-scale SOFCs may be printed and connected in electrical series to produce high-voltage, low-current, and high-efficiency devices using cost-effective fabrication methods. Furthermore, the cost associated with fabricating the fuel cell may be reduced compared to other fuel cells because the fabrication may occur at ambient conditions (i.e. no vacuum required). The invention also utilizes low-cost ceramic interconnect materials rather than the high-cost precious metals currently utilized for electrical connection between cells.

Cell materials, including for example, a composite nickel/yttria-stabilized zirconia anode, yttria-stabilized zirconia (YSZ) electrolyte, strontium-doped lanthanum manganate cathode, and lanthanum-doped strontium titanate (SLT), interconnect to form a segmented-in-series fuel cell. Inks are formulated for use in the inkjet printers from commercially sourced powders, and printed onto porous, chemically inert supports. Using inkjet printing technology under ambient environments, accurate registration of SOFC materials is observed at a feature size as low as about 25 μm. Some embodiments include a high-temperature sintering, dense and porous ceramic layers that may be formed over the porous substrate. The manufacturing method enables low-cost fabrication of a high-voltage, low-current electrical generator without use of high-cost metallic interconnects.

One aspect of the invention is a method to produce a segmented-in-series fuel cell, the method comprising: providing an inkjet printer; applying at least one first layer to a substrate with the inkjet printer; and applying at least one additional layer to the first layer with the inkjet printer, wherein a material for the at least one first layer is different from a material for the at least one additional layer, and wherein the material for the at least one first layer comprises at least one of an anode material or an interconnection material, and wherein the material for the at least one additional layer comprises at least one of an electrolyte material, an anode material, a interconnect material or a cathode material.

One aspect of the invention is a method to prepare an ink for use in an inkjet printer, the method comprising: dispersing a powder in a dispersant and a hyperdispersant, wherein the powder comprises at least one of NiO, YSZ, SLT, LSM and combinations thereof.

One aspect of the invention is an ink for use in an inkjet printer to fabricate segregated-in-series fuel cell, the ink comprising: a powder, wherein the powder comprises at least one of NiO, YSZ, SLT, LSM, LSCF, LCO, CeO₂, CGO combinations thereof a dispersant; and a hyperdispersant.

One aspect of the present invention is a fuel cell. In some embodiments, the fuel cell comprises a substrate, at least one first layer, wherein the first layer comprises at least one of an interconnection layer, an anode layer, an electrolyte layer and a cathode layer, and at least one second layer, wherein the second layer comprises at least one of an interconnection layer, an anode layer, an electrolyte layer and a cathode layer, and wherein the at least one first layer and the at least one second layer are different materials.

The term “layer” is used throughout the specification. “Layer” may be interpreted to mean a single layer or at least one layer.

### BRIEF DESCRIPTION OF THE DRAWINGS

FIG. 1 illustrates a segmented-in-series solid-oxide fuel cell;

FIG. 2 depicts scanning electron micrographs of a cross-section of a partially stabilized zirconia support before and after high temperature sintering;

FIG. 3 depicts cross-section and surface scanning electron micrographs of a partially stabilized zirconia support coated with a dense YSZ layer;

FIG. 4 illustrates viscosity of NiO (6.6 vol. % oxide to solvent) and YSZ (8.5 vol. % oxide to solvent) dispersed in α-Terpineol for several Lubrizol Solsperse hyperdispersant systems;

FIG. 5 depicts electron micrographs of cross-sections of NiO electrodes deposited on sintered partially stabilized zirconia supports;

FIG. 6 depicts an electron micrograph of multilayered structures deposited onto a partially stabilized zirconia support; and

FIG. 7 illustrates voltage of a cell as a function of time.

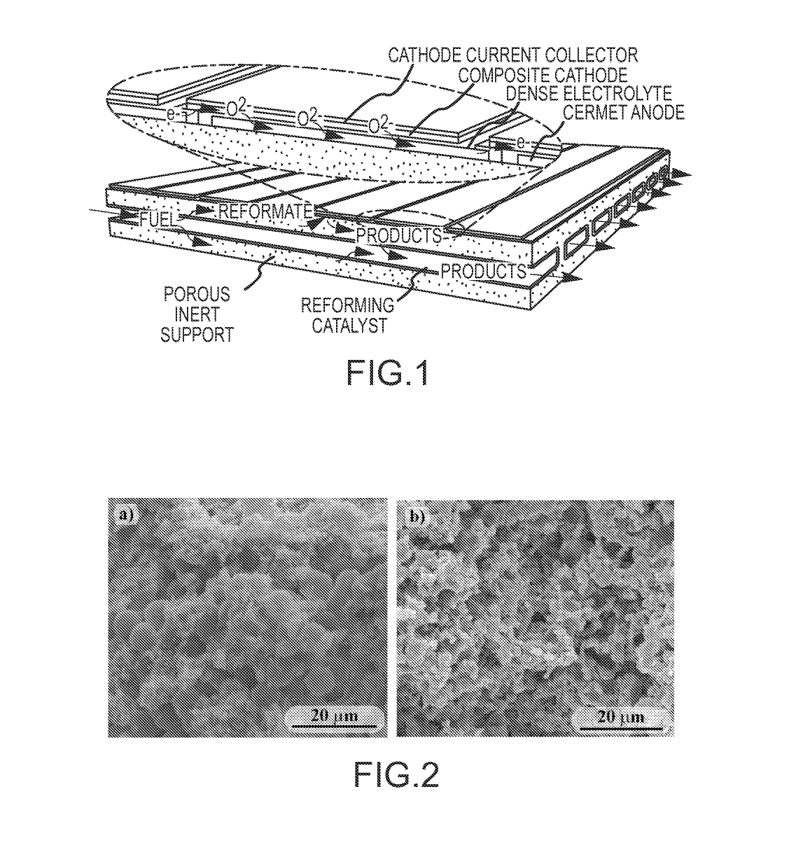

### DETAILED DESCRIPTION

The present invention relates to a segmented-in-series (SIS) fuel cell and a method for making the same. The present invention also relates to the ink used to make the fuel cell and a method for making the same.

One aspect of the invention is a method to manufacture a SIS fuel cell. The method for making the SIS fuel cell comprises providing an inkjet printer, applying at least one first layer to a substrate with the inkjet printer, applying at least one additional layer to the first layer with the inkjet printer, wherein a material for the at least one first layer is different from a material for the at least one additional layer, and wherein the material for the at least one first layer comprises at least one of an anode material or an interconnection material, and wherein the material for the at least one additional layer comprises at least one of an electrolyte material, an anode material, a interconnect material or a cathode material.

The substrate may be any suitable material. The substrate may be a porous inert substrate. Some suitable porous inert substrates include, but are not limited to, yttria partially stabilized zirconia, yttria stabilized zirconia, alumina, ceria and the like. The thermal expansion of the substrate material may be less than about 13 ppm/° C. In some embodiments, the thermal expansion of the substrate material may be between about 8 ppm/° C. and about 13 ppm/° C. In some embodiments, the thermal expansion of the substrate material may be about 11.5 ppm/° C. In some embodiments, the thickness of the substrate may be between about 0.02 inches and about 0.12 inches. In preferred embodiments, the substrate may be about 0.04 inches thick. In some embodiments, the width of the substrate may be between about 0.5 inches and about 36 inches. In preferred embodiments, the substrate may be about 18 inches wide. In some embodiments, the length of the substrate may be between about 0.5 inches and about 36 inches. In some embodiments, the length of the substrate may be about 18 inches long.

In some embodiments, the support may be produced by dispersing a support powder in a solvent and dispersant to create a suspension, mixing the suspension for between about 1 minute to about 48 hours. The solvent may be water, or an alcohol including but not limited to IPA, methanol, ethanol, and propanol. Any suitable dispersant may be used, including but not limited to ammonium polymethacrylate, such as Darvan C. Optionally, beads may be added to the suspension in order to facilitate high porosity in the support. By way of example, poly(methyl methacrylate) (PMMA) beads may be added to the suspension. A binding agent, including but not limited to polyethylene glycol, may also be added to the suspension. The solvent may be evaporated resulting in a precipitate. The precipitate is crushed, using any suitable method, including but not limited to with a mortar and pestle. The crushed precipitate may be passed through a mesh screen. The screen may be between −325 and −60 mesh (about 44 microns to about 250 microns). The powder is dry pressed into a final shape under a pressure of between about 25 MPa to about 150 MPa, in some embodiments about 40 MPa, for between about 1 second to about 1 minute, in some embodiments about 12 seconds. The pressed powder is then sintered for between 5 minutes to about 20 hours, in some embodiments about one hour at a temperature of between about 1000° C. to about 1600° C., in some embodiments about 1450° C.

One or more interconnection layers may be applied to the substrate with the inkjet printer. The interconnection layer connects a fuel cell to an adjacent fuel cell. In some embodiments, the interconnection layer connects fuel cells such that the fuel cells are in series with each other thereby creating more voltage output as compared to fuel cells that are in parallel with each other. The interconnection layer may be any suitable electronically conducting material. Some electronically conducting materials include, but are not limited to: metals such as platinum, silver, nickel, copper, and perovskite ceramics, including but not limited to, strontium titanate, lanthanum strontium ferrite, lanthanum coboltite (LCO) and the like. In some embodiments, the interconnection layer may be between about 5 microns and about 50 microns. In preferred embodiments, the nominal thickness of the interconnection layer may be about 25 microns. Furthermore, it is understood that the thickness of the interconnection layer may vary over the substrate. If the interconnection layer is too thin, then the fuel cells become overheated, while if the interconnection layer is too thick, then the fuel cell does not adhere correctly to the substrate. The interconnection layer may be applied directly to the substrate such that it substantially overlaps the entire substrate, or it may be applied to less than the entire substrate. In some embodiments, the interconnection layer may be applied to between about 0% to about 50% of the substrate. In some embodiments, the interconnection layer may be applied to between about 5% to about 50% of the substrate. In some embodiments, the interconnection layer may be applied to between about 10% to about 15% of the substrate. In some embodiments, the interconnection layer may be applied to between about 5% to about 50% of the substrate. In some embodiments, the interconnection layer may be applied to about 5% of the substrate; 10% of the substrate; about 15% of the substrate; about 20% of the substrate; about 25% of the substrate; about 30% of the substrate; about 35% of the substrate; about 40% of the substrate; about 45% of the substrate; and about 50% of the substrate.

One or more anode layers may be applied to the substrate, the interconnection layer or combinations thereof with the inkjet printer. The anode layer material may be any mixed electronic ionic conductor material. Suitable anode layer materials include, but are not limited to, nickel-yttria-stabilized zirconia, nickel-gadolinium doped ceria, nickel-lanthanum strontium gadolinium maganate, nickel-strontium stabilized zirconia, ceramic metallic composite, copper-yttria-stabilized zirconia and the like. In some embodiments, the anode layer may be between about 5 microns and about 50 microns. In preferred embodiments, the nominal thickness of the anode layer may be about 25 microns. In some embodiments, multiple thin layers are applied in order to achieve an anode layer of between about 5 microns to about 50 microns. In some embodiments, each anode layer is at least about 25 microns. Furthermore, it is understood that the thickness of the anode layer may vary over the substrate and/or the interconnection layer. The anode layer may be applied directly to the substrate and/or interconnection layer such that it substantially overlaps the entire substrate and/or interconnection layer, or it may be applied to less than the entire substrate and/or interconnection layer. In some embodiments, the anode layer may be applied to between about 50% to about 90% of the substrate. In some embodiments, the anode layer covers the remainder of the substrate that is not covered by the interconnection layer. In some embodiments, the anode layer may be applied to between about 75% to about 90% of the substrate. In some embodiments, the anode layer may be applied to between about 85% to about 90% of the substrate. In some embodiments, the anode layer may be applied to about 50% of the substrate; about 55% of the substrate; about 60% of the substrate; about 65% of the substrate; about 70% of the substrate; about 75% of the substrate; about 80% of the substrate; about 85% of the substrate; about 90% of the substrate; about 95% of the substrate; about 97% of the substrate; about 98% of the substrate; about 99% of the substrate and about 100% of the substrate. In some embodiments, the anode layer may be applied to at most about 40% of the interconnection layer. In some embodiments, the anode layer may be applied to between about 5 to about 40% of the interconnection layer. In some embodiments, the anode layer may be applied to between about 10% to about 30% of the interconnection layer. In some embodiments, the anode layer may be applied to about 5% of the interconnection layer; about 10% of the interconnection layer; about 15% of the interconnection layer; about 20% of the interconnection layer; about 25% of the interconnection layer; about 30% of the interconnection layer; about 35% of the interconnection layer; and about 40% of the interconnection layer.

One or more electrolyte layers may be applied to the interconnection layer and/or the anode layer with the inkjet printer. The electrolyte layer may be any suitable material. The material may be any suitable ceramic ionic conductors. Some ceramic ionic conductor materials include, but are not limited to yttria-stabilized zirconia; gadolinium doped ceria (CGO), lanthanum strontium gadolinium maganate, strontium stabilized zirconia, and the like. In some embodiments, the electrolyte layer may be between about 5 microns and about 50 microns. In preferred embodiments, the nominal thickness of the electrolyte layer may be about 10 microns. Furthermore, it is understood that the thickness of the electrolyte layer may vary over the anode layer and/or interconnection layer. The electrolyte layer may be applied directly to the anode layer and/or interconnection layer such that it substantially overlaps the entire anode layer and most of the interconnection layer, up to about 95% of the interconnection layer. In some embodiments, the electrolyte layer may be applied to between about 25% to about 95% of the interconnection layer. In some embodiments, the electrolyte layer may be applied to between about 40% to about 80% of the interconnection layer. In some embodiments, the electrolyte layer is applied to about 25% of the interconnection layer; about 30% of the interconnection layer; about 35% of the interconnection layer; about 40% of the interconnection layer; about 45% of the interconnection layer; about 50% of the interconnection layer; about 55% of the interconnection layer; about 60% of the interconnection layer; about 65% of the interconnection layer; about 70% of the interconnection layer; about 75% of the interconnection layer; about 80% of the interconnection layer; about 85% of the interconnection layer; about 90% of the interconnection layer; and about 95% of the interconnection layer.

In another embodiment, one or more cathode layers may be applied to the electrolyte layer with the inkjet printer. The cathode layers may be any electrically conductive ceramics material, or a mixed electronic ionic conductor ceramic. Some electrically conductive ceramics or mixed electronic ionic conducting ceramics include, but are not limited to, perovskite ceramic, strontium-doped lanthanum magnate, lanthanum strontium ferrite, lanthanum strontium cobalt ferrite (LSCF), lanthanum coboltite and the like. In some embodiments, the cathode layer material is a cathode composite material wherein the cathode material is combined with an electrolyte material to make the composite material. Suitable materials are discussed herein. This composite allows for ionic conduction as well as electrical conduction. If a cathode composite material is used in the cathode layer, then an electrolyte material may still be applied separately to the interconnection layer and the anode layer. In some embodiments, the cathode layer or cathode composite material may be between about 5 microns and about 50 microns. In preferred embodiments, the nominal thickness of the cathode layer may be about 25 microns. Furthermore, it is understood that the thickness of the cathode layer may vary over the electrolyte layer. The cathode layer may be applied directly to the electrolyte layer such that it substantially overlaps the entire electrolyte layer, or it may be applied to less than the entire electrolyte layer. In some embodiments, the cathode layer may be applied to up to about 95% of the electrolyte layer. In some embodiments, the cathode layer may be applied to between about 25% to about 95% of the electrolyte layer. In some embodiments, the cathode layer may be applied to between about 80% to about 95% of the electrolyte layer. In some embodiments, the cathode layer may be applied to about 80% of the electrolyte layer; about 85% of the electrolyte layer; about 90% of the electrolyte layer; and about 95% of the electrolyte layer.

In some embodiments, a cathode current collector may be applied to the cathode layer. In some embodiments, the cathode layer may be a composite. This porous layer provides higher electronic conductivity than is commonly found in the cathode layer.

Though the layers may be applied in a variety of combinations, in some embodiments, the layers of the SIS fuel cell may be applied to a portion of the substrate as follows: the interconnect layer, the anode layer, the electrolyte layer and the cathode layer. In other embodiments, the layers of the SIS fuel cell may be applied to a portion of the substrate as follows: interconnect layer, electrolyte layer, and the cathode layer. In some embodiments, the layers of the SIS fuel cell may be applied to a portion of the substrate such that a portion of the SIS fuel cell has different layers applied to it than another portion of the SIS fuel cell. Thus, in some embodiments, at least one material of the SIS fuel cell is applied to a portion of the substrate, where the layers are selected from the group consisting of an interconnect layer, an anode layer, an electrolyte layer, a cathode layer and combinations thereof, and wherein layers in a second portion of the SIS fuel cell are applied such that the second portion comprises different layers or a different layer combination from the first portion of the SIS fuel cell, wherein the second portion layers are selected from the group consisting of the interconnection layer, the anode layer, the electrolyte layer, the cathode layer and combinations thereof. Furthermore, other portions of the substrate may differ from the first and second portion. By way of non-limiting example, the layers of the SIS fuel cell may be applied to a portion of the substrate as follows: the interconnect layer, the anode layer, the electrolyte layer and the cathode layer; while in another portion of the substrate the SIS fuel cell layer may be applied to the substrate as follows: interconnect layer, electrolyte layer, and the cathode layer; while in still other portions of the SIS fuel cell, the layers of the SIS fuel cell may be applied as follows: anode layer, electrolyte layer, and cathode layer; while in still other portions of the SIS fuel cell, the layers of the SIS fuel cell may be applied as follows: electrolyte layer, and cathode layer; and combinations thereof.

In some embodiments, a portion of the substrate may be covered by a sealer. In some embodiments, the sealer covers between about 10% to about 99% of the portion of the substrate not covered by the fuel cell layers. In another embodiment, approximately the entire portion of the substrate not covered by the fuel cell may be covered by a sealer. The sealer may be any suitable sealer, including but not limited to, yttria-stabilized zirconia, alumina, ceria, partially stabilized zirconia (PSZ), and the like. A sealer may be applied by masking the portions of the substrate covered with the fuel cell, then applying the sealer by spraying, dipping, painting, wiping, and the like. The sealer may be in the form of a slurry. The thickness of the sealer may be between about 10 microns to about 100 microns, in some embodiments about 25 microns. After applying the sealer, the fuel cell may remain unsintered. However, in some embodiments, the fuel cell may be co-sintered at between about 1000° C. to about 1600° C., preferably about 1150° C., after a binder-burnout stage at about 300° C. The fuel cell may be sintered for between 5 minutes to about 20 hours. In some embodiments, the fuel cell may be sintered for about 3 hours.

The application of the layers may occur at ambient conditions. However, in some embodiments, the fuel cell may be sintered at between about 1000° C. and about 1600° C. following the application of the one or more layers, the sealer or during substrate formation. By way of example, the compositions of a fuel cell without a cathode layer may be sintered prior to the application of the cathode layer. Following the application of a cathode layer, the fuel cell may be again sintered at the same temperature or at a different suitable temperature between about 1000° C. and about 1600° C. The fuel cell in any of these steps may be sintered for between 5 minutes to about 20 hours. In some embodiments, the fuel cell may be sintered for about 3 hours.

In some embodiments, the substrate may be cleaned prior to the application of the interconnection layer and/or the anode layer. In some embodiments, a detergent, a polar solvent, a non-polar solvent and combinations thereof may be used to clean the substrate. The substrate may be cleaned using a detergent and water. In some embodiments, the polar solvent may be selected from the group consisting of alcohol, ethanol, isopropyl alcohol, water, methanol, ammonium hydroxide, ammonium chloride, combinations thereof and the like. In some embodiments, the non-polar solvent may be selected from the group consisting of acetone, hexane, toluene, chloroform, combinations thereof and the like. Processes such as vapor degreasing may also be used to clean the substrate. In some embodiments, the substrate may be baked in an oven (under vacuum or at atmospheric pressure) at a temperature up to about 1200° C. for a sufficient period of time, usually between about 1 minute to about one month. The substrate may be baked after cleaning or may be baked in order to clean the substrate.

One aspect of the present invention is a fuel cell. In some embodiments, the fuel cell comprises a substrate, at least one first layer, wherein the first layer comprises at least one of an interconnection layer, an anode layer, an electrolyte layer and a cathode layer, and at least one second layer, wherein the second layer comprises at least one of an interconnection layer, an anode layer, an electrolyte layer and a cathode layer, and wherein the at least one first layer and the at least one second layer are different materials. In some embodiments, the fuel cell further comprises a sealer. In some embodiments, the thickness of the fuel cell may be between about 500 microns to about 4000 microns. In preferred embodiments, the fuel cell may be about 0.04 inches thick. In some embodiments, the width of the fuel cell may be between about 0.5 inches and about 36 inches. In preferred embodiments, the fuel cell may be about 18 inches wide. In some embodiments, the length of the fuel cell may be between about 0.5 inches and about 36 inches. In some embodiments, the length of the fuel cell may be about 18 inches long.

In some embodiments, the fuel cell covers a portion of the surface of the substrate. In some embodiments, the fuel cell covers at least about 5% of the surface of the substrate. In some embodiments, the fuel cell covers at least about 20% of the surface of the substrate. In other embodiments, the fuel cell covers at least about 40% of the surface of the substrate. In still other embodiments, the fuel cell covers at least about 50%, 60%, 70%, 80%, 90% or 95% of the surface of the substrate. In other embodiments, the fuel cell covers between about 50% to about 95% of the surface of the substrate. In still other embodiments, the fuel cell covers the entire surface of the substrate.

Another aspect of the invention is the preparation of the ink for applying layers of the fuel cell with the inkjet printer. A powder is dispersed in a dispersant and a hyperdispersant. The powder comprises at least one of NiO, YSZ, SLT, LSM, LSCF, LCO, CeO₂, CGO and combinations thereof.

Any suitable dispersant may be used. In some embodiments, the dispersant is α-Terpineol. The dispersant may be ethylene glycol. Similarly, any suitable hyperdispersant may be used. By way of non-limiting example, the hyperdispersant may be Solsperse 13940.

The powder is selected from the group consisting of NiO, YSZ, SLT, LSM or combinations thereof. The powder may be NiO. The percent solid loading may be between about 5% to about 15%. Percent solid loading is the mass of the ceramic material within the solvent as a percentage of the solvent mass. Suitable solvents include deionized water, terminal.

The ink itself used in an inkjet printer to fabricate a SIS fuel cell is another aspect of the invention. The ink comprises a powder, wherein the powder the powder comprises at least one of NiO, YSZ, SLT, LSM, LSCF, LCO, CeO₂, CGO combinations thereof, a dispersant, and a hyperdispersant.

Any suitable dispersant may be used. In some embodiments, the dispersant may be α-Terpineol. Alternatively, the dispersant may be ethylene glycol. Similarly, any suitable hyperdispersant may be used. By way of non-limiting example, the hyperdispersant may be Solsperse 13940.

The powder is selected from the group consisting of NiO, YSZ, SLT, LSM or combinations thereof. The powder may be NiO. The percent solids loading for NiO may be between about 5% to about 15%.

### Examples

The following example is a fuel cell developed with the process outlined herewith.

### Support Formation

Yttria partially stabilized zirconia was used as the substrate material (YPSZ). The mixture of metastable tetragonal-phase zirconia within cubic phase zirconia in PSZ leads to high strength and high fracture toughness. Additionally, the low ionic and electronic conductivity of PSZ decreased the likelihood of electrical shorting between adjacent cells. Finally, the thermal expansion properties of PSZ are similar to that of the other SOFC materials.

To create the porous SIS support, 3 mol. % yttria-stabilized zirconia powder was dispersed in water using Darvan C (ammonium polymethacrylate) and then balled-milled for about 24 hours using zirconia media. To facilitate high porosity in the substrate, about 6 micron diameter poly (methyl methacrylate) (PMMA) beads were added to the suspension, along with polyethylene glycol as a binding agent. The complete support formulation is shown in Table 1.

TABLE 1
Substrate formulation

| Constituent | Mass %* |
|---|---|
| PSZ powder | 36.00 |
| Dispersant (Darvan C) | 0.54 |
| Binder (Polyethylene glycol) | 3.78 |
| Pore former (about 6 micron diameter | 8.80 |
| PMMA beads) | |
| Solvent (de-ionized water) | 50.90 |

*Mass percent includes the mass of the solvent.

After the solvent was evaporated, the resulting precipitate was crushed using a mortar and pestle then screened between −325 and −60 mesh sieves. The resulting powder was uniaxially dry pressed into circular discs using with an 57 mm or 28.6 mm stainless steel die under a pressure of about 40 MPa for about 12 seconds. After the pressed powdered was sintered at about 1450° C. for about one hour, the porosity of the support was found to be about 45% using Archimedes method. FIG. 2 illustrates scanning electron micrographs of an unsintered and sintered support. PMMA beads are clearly evident in FIG. 2a, while FIG. 2b illustrates an open pore structure.

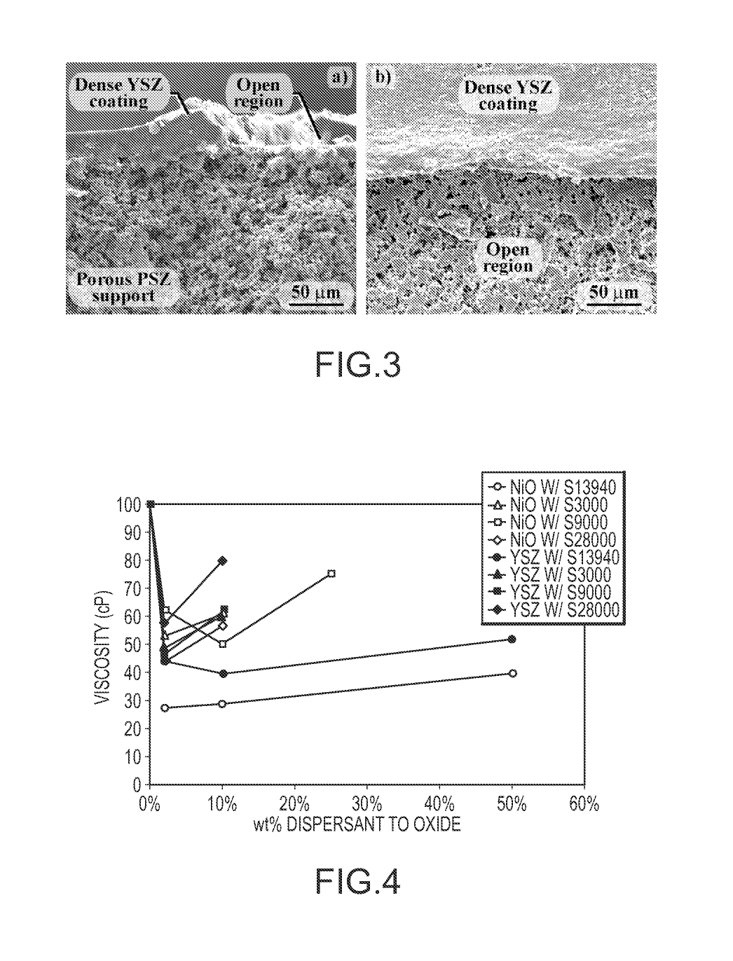

The electrochemically active layer was applied to a fraction of the substrate. The inactive region was sealed in order to prevent fuel leakage through the porous support into the air chamber of the SIS device. A dense 8 mol % YSZ coating was applied over the inactive porous regions of the substrate. The active region was masked and then the substrate was dipped into a YSZ slurry. Though sintering of the substrate occurred in a separate step at high temperature, the entire fuel cell may be sintered together. FIG. 3 illustrates scanning electron micrographs of a PSZ support coated with a dense YSZ layer. FIG. 3a is a cross section of the coated support, while FIG. 3b is a surface image.

### Ink Formulation

For the present example, the inkjet printer, a Dimatix drop-on-demand, used piezo-electric print heads to form and deposit the drops of ink. The piezo-electric print heads allow for very small amounts of material to be applied in a controlled manner. Thus, any print head that may apply ink in a controlled manner may be suitable. For appropriate droplet formation, inks must possess certain characteristics, the most important of which is viscosity, which should be between about 10 cP to about 12 cP. Due to the low-viscosity requirements of the printer, α-Terpineol was used as the ink solvent, as the viscosity of α-Terpineol may easily be tailored with temperature. The printer can heated the print head, which enabled control of the ink viscosity.

In addition to meeting viscosity requirements, the particle size of the solids in the ink must be kept under about 1 micron in diameter in order to prevent printhead-nozzle clogging. While ceramic powders of sub-micron particle size may be easily obtained from commercial sources, these particles may agglomerate within the ink, leading to larger particle sizes and rapid nozzle clogging.

In an effort to develop a colloidal suspension that enabled adequate particle dispersion and prevented agglomeration, dispersion studies were conducted using an approximately 6.6 vol. % to about 8.5 vol. % oxide to solvent solids loading. Four sets of dispersion studies are conducted (one for each of the inks) using α-Terpineol as the solvent, and NiO, YSZ, SLT, and LSM as the oxides.

The effectiveness of numerous dispersants was tested in each study. Lubrizol Solsperse dispersants were utilized based on their success in previously published works. Dispersant samples were mixed with various oxides in the α-Terpineol solvent over a range of dispersant-additional levels.

After mixing dispersants with solvent and oxides, the samples were milled overnight to break down agglomerates and ensure complete mixing. As an indication of dispersion, the viscosity of the various samples was measured as a function of dispersant added. Viscosity was measured using a Brookfield DV-E viscometer with a ULA low-volume spindle rotating at about 10 RPM. Results for the NiO and YSZ dispersion studies are shown in FIG. 4.

The Solsperse 13940 hyperdispersant (designated S13940) yields the lowest viscosities for both NiO and YSZ materials. This dispersant was an about 40%-active polymeric dispersant, and was effective in liquid organic media, making it well matched to the α-Terpineol solvent system.

The viscosities of the NiO and the YSZ inks in the absence of dispersant exceed the range of the viscometer at the given speed of about 10 RPM and are therefore represented as a value of 100 cP in FIG. 4. According to manufacturer specifications, the appropriate Solsperse 13940 theoretical dosage was 2 wt. % for the NiO surface area (about 3-4 m²/g) and about 10 wt. % for the YSZ surface area (about 13-19 m²/g). The results in FIG. 4 correspond well with these theoretical dosages. Therefore, the Lubrizol Solsperse 13940 was utilized as the dispersant system for the NiO and YSZ inks.

A similar dispersion study was conducted for the SLT interconnect ink using the Solsperse 13940 dispersant. The finalized ink compositions chosen for SLT, NiO, and YSZ are provided in Table 2. All values were approximate.

TABLE 2
Ink compositions.

| | | | Interconnect |
|---|---|---|---|
| Material | Anode Ink (g) | Electrolyte Ink (g) | Ink (g) |
| α-Terpineol | 18.77 | 18.77 | 18.77 |
| NiO | 8.8 | 0 | 0 |
| YSZ | 0 | 7.79 | 0 |
| SLT | 0 | 0 | 6.99 |
| Solsperse 13940 | 0.18 | 0.16 | 0.14 |

A dispersant-to-oxide ratio of about 2 wt. % was used for each ink. As observed in FIG. 4, the colloidal suspensions have a viscosity greater than the Dimatix-recommended value of about 10 cP to about 12 cP. Therefore, it is necessary to increase the cartridge temperature to about 50° C. during printing, in order to adequately decrease ink viscosity.

In order to deposit the ceramic ink using the printer, a jetting waveform was used to control the piezo-electric print heads. Using the formulated inks, the heated cartridge nozzles eject one drop at a time. This drop-on-demand feature and integrated fiducial camera enabled precise registration of the printed patterns. The SLT, NiO, and YSZ components were printed onto unsintered “green” PSZ supports, and then subsequently co-sintered to about 1450° C. after a binder-burnout stage at about 300° C. Printing onto unsintered PSZ supports decreased the number of high-temperature sintering, or heating, steps, increasing throughput. Additionally, the green supports were essentially dense materials, which minimized the wicking of inks into the support body during ink deposition.

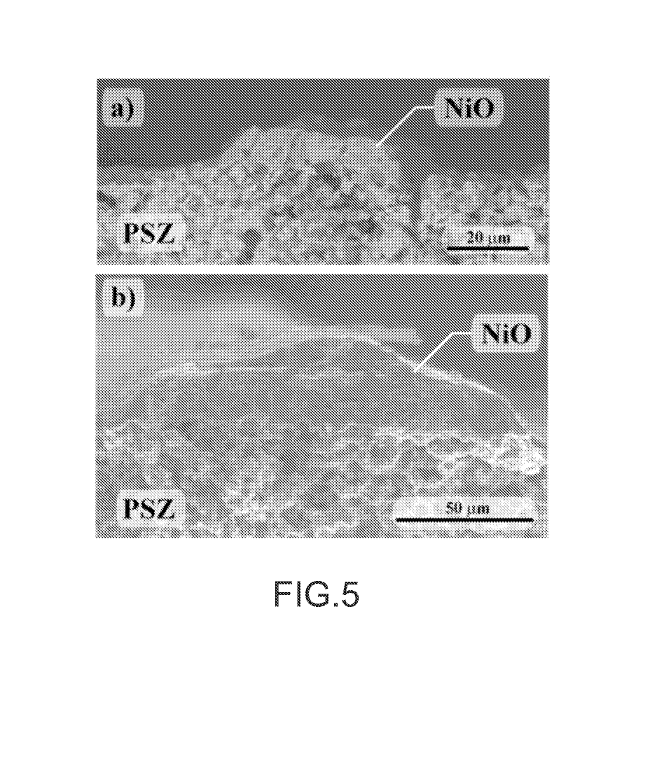

High-resolution electron micrographs of two fracture cross-sections of NiO electrodes deposited onto PSZ supports are illustrated in FIG. 5. Electrode width was considerably varied by altering printing parameters, with a width of about 25 microns illustrated in FIG. 5a. A wider electrode (about 140 microns) was illustrated in FIG. 5b, with a more-desirable structure, thickness and uniformity over the PSZ support, though some peaking in the center of the electrode was evident. Good adherence between the NiO electrode and the PSZ support was also evident.

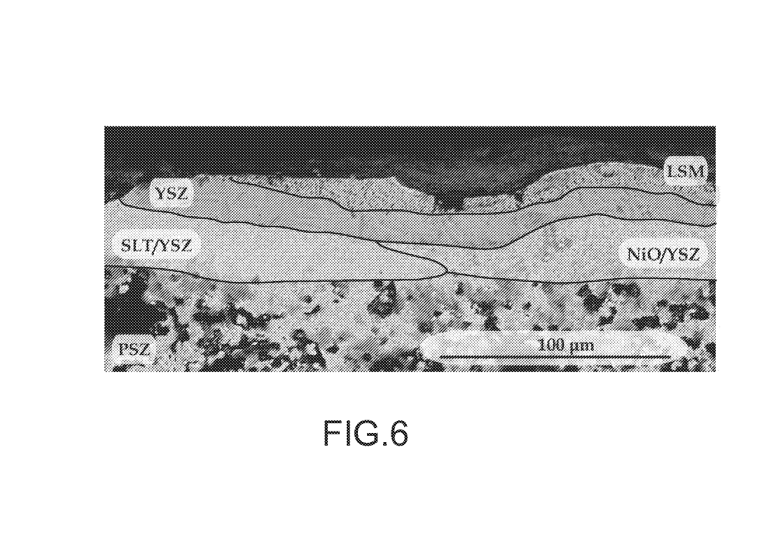

Electron micrograph images of multilayered structures are illustrated in FIG. 6. Boundary lines have been added to FIG. 6 for clarity. In fabricating the devices shown in these images, the fifteen passes of the SLT interconnect material was first printed onto the PSZ support (about 25 microns thick), followed by deposition of fifteen passes of the NiO anode material (about 25 microns), and then eight passes of the YSZ electrolyte material (about 14 microns thick). Finally, about ten passes of the cathode material was applied (about 12 microns thick). As illustrated in the FIG. 6, neither the anode layer, nor the interconnection layer completely covered the substrate layer. The deposited layers were co-sintered with the PSZ support. Good adherence between layers was evident, as well as accurate registration of successive layers. A low level of porosity was observed in the YSZ and SLT layers, as desired. While some variability in the thickness of the successive layers was evident, particularly near the edges of each layer, the bulk layer thickness was approximately 15 microns for each material.

### Performance

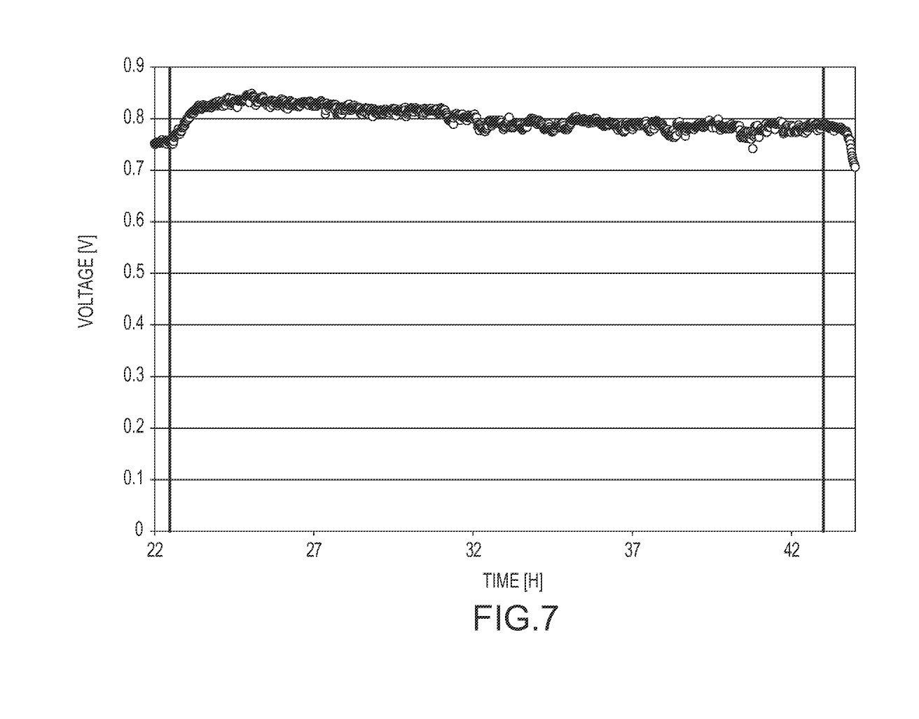

An example of a segmented-in-series fuel cell fabricated by the described technique is illustrated in FIG. 7. This figure illustrates the electric potential generated over a twenty-hour period by the single segmented-in-series fuel cell fabricated by ink jet printing. To make this measurement, the fuel cell was packaged within inert ceramic manifolds, with air fed to cathode side of the device, and an about 97% hydrogen, about 3% H2O mixture fed to the anode side of the device. The fuel cell was placed in a furnace, and heated to about 800° C. Silver-wire electrical connections were made to the anode and cathode interconnects. The electric potential was fairly constant, near about 0.8 V, though some performance degradation was observed.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method to produce a segmented-in-series fuel cell, the method comprising:
providing an inkjet printer;
applying at least one first layer to a substrate with the inkjet printer; and
applying at least one additional layer to the first layer with the inkjet printer, wherein a material for the at least one first layer is different from a material for the at least one additional layer, and wherein the material for the at least one first layer comprises at least one of an anode material or an interconnection material, and wherein the material for the at least one additional layer comprises at least one of an electrolyte material, an anode material, a interconnect material or a cathode material.

2. The method of claim 1, further comprising applying a third layer to the second layer, wherein a material for the third layer is a cathode material.

3. The method of claim 1, further comprising applying a second first layer to the substrate with the inkjet printer, wherein the first layer and the second first layer are different materials, and wherein the first material is the anode material and wherein a material for the second first layer is an interconnection material.

4. The method of claim 1, further comprising applying a cathode composite to the cathode layer.

5. The method of claim 4, further comprising applying a cathode current collector to the one or more layers of the composite cathode.

6. The method of claim 1, wherein the first layer material is an anode material and wherein a width of the at least one first layers is at least about 25 microns.

7. The method of claim 1, wherein the at least one first layer covers a portion of the substrate.

8. The method of claim 7, wherein the at least one first layer covers between about 80% to about 95% of the substrate.

9. The method of claim 1, wherein further comprising sealing a portion of the substrate with a sealer, wherein the sealer is a dense ceramic material and wherein the dense ceramic material is selected from the group consisting of yttria-stabilized zirconia, alumina, ceria, PSZ and combinations thereof.

10. The method of claim 1, further comprising sintering the substrate after the application of the at least one first layer and the at least one second layer at a temperature of between about 1000° C. to about 1600° C.

11. A method to prepare an ink for use in an inkjet printer, the method comprising:
dispersing a powder in a dispersant and a hyperdispersant, wherein the powder comprises at least one of NiO, YSZ, SLT, LSM, LSCF, LCO, CeO₂, CGO and combinations thereof.

12. The method of claim 11, wherein the dispersant is α-Terpineol.

13. The method of claim 11, wherein the hyperdispersant is Solsperse 13940.

14. The method of claim 11, wherein the powder is a NiO and wherein the percent solids loading is between about 5-15%.

15. The method of claim 11, wherein the powder is YSZ and wherein the percent solids loading is between about 5-15%.

16. The method of claim 11, wherein the powder is SLT and wherein the percent solids loading is between about 5-15%.

17. The method of claim 11, wherein the powder is LSM and wherein the percent solids loading is between about 5-15%.

18. An ink for use in an inkjet printer to fabricate segregated-in-series fuel cell, the ink comprising:
a powder, wherein the powder comprises at least one of NiO, YSZ, SLT, LSM, LSCF, LCO, CeO₂, CGO and combinations thereof;
a dispersant; and
a hyperdispersant.

19. The ink of claim 18, wherein the dispersant is α-Terpineol and wherein the hyperdispersant is Solsperse 13940.

20. The ink of claim 18, wherein a percent solids loading is between about 5-15%.
